(19) United States
(12) Patent Application Publication
(10) Pub. No.: US 2017/0171744 A1
(43) Pub. Date: Jun. 15, 2017

(54) PROTECTING AND/OR ANONYMIZING A USER IDENTITY AND/OR USER DATA OF A SUBSCRIBER OF A DATA PROTECTION SERVICE

(71) Applicant: DEUTSCHE TELEKOM AG, Bonn (GB)

(72) Inventor: Graham Thomas, Camberley, Surrey (GB)

(73) Assignee: DEUTSCHE TELEKOM AG, Bonn (DE)

(21) Appl. No.: 15/300,299

(22) PCT Filed: Mar. 3, 2015
(86) PCT No.: PCT/EP2015/054370

§ 371 Date: Sep. 29, 2016

(30) Foreign Application Priority Data
Mar. 31, 2014 (EP) 14162870.1

(51) Int. Cl. H04W 12/02; G06F 21/62; H04L 29/06

(52) U.S. Cl. CPC H04W 12/02; H04L 63/0421; G06F 21/6245

(57) ABSTRACT

A method for protecting and/or anonymizing a user identity and/or user data of a subscriber of a data protection service includes: accessing, by a computing device of the subscriber, the data protection service via the telecommunications network; and accessing, by the computing device, a third party service via the data protection service such that the third party service receives user-related data, Accessing the third party service via the data protection service involves a transmission of the user-related data such that the user identity and/or the user data are at least partly protected and/or anonymized with respect to the third party service by at least partly avoiding transmission of plaintext of the user identity and/or the user data to the third party service or by the user-related data transmitted to the third party service being modified data with respect to the user identity and/or user data.

### CROSS-REFERENCE TO RELATED APPLICATIONS

This application is a U.S. National Phase application under 35 U.S.C. §371 of International Application No. PCT/EP2015/054370, filed on Mar. 3, 2015, and claims benefit to European Patent Application No. EP 14162870.1, filed on Mar. 31, 2014. The International Application was published in English on Oct. 8, 2015 as WO 2015/150006 Al under PCT Article 21(2).

### FIELD

The present invention relates to a method for protecting and/or anonymizing a user identity and/or user data of a subscriber of a data protection service.

Furthermore, the present invention relates to a system for protecting and/or anonymizing a user identity and/or user data of a subscriber of a data protection service.

Additionally, the present invention relates to a mobile communication network suitable for protecting and/or anonymizing a user identity and/or user data of a subscriber of a data protection service.

### BACKGROUND

Some third party services, e.g. so called context-aware services, typically use contextual elements to learn about a user's behaviour and situation, wherein smart recommendations may be provided to the user. For example, a service may ask to access email and other user data in order to act as a personal assistant. However, the third party services require personal information of the user in order to provide the service targeted to the user. Thus, the privacy protection of the user is relatively low because personal information may be misused or sold to other organizations by the companies associated with the third party services.

### SUMMARY

In an exemplary embodiment, the present invention provides a method for protecting and/or anonymizing a user identity and/or user data of a subscriber of a data protection service, comprising: accessing, by a computing device of the subscriber connected to a telecommunications network, the data protection service via the telecommunications network; and accessing, by the computing device, a third party service via the data protection service such that the third party service receives user-related data, the user-related data being data related to the user identity and/or the user data. Accessing the third party service via the data protection service involves a transmission of the user-related data such that the user identity and/or the user data are at least partly protected and/or anonymized with respect to the third party service by at least partly avoiding transmission of plaintext of the user identity and/or the user data to the third party service or by the user-related data transmitted to the third party service being modified data with respect to the user identity and/or user data.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a system according to the present invention.

### DETAILED DESCRIPTION

Exemplary embodiments of the present invention provide a method, a system and a mobile communication network for protecting and/or anonymizing a user identity and/or user data of a subscriber of a data protection service such that the user-convenience is improved with regard to third party services being provided via the telecommunications network.

In an embodiment, the present invention provides a method for protecting and/or anonymizing a user identity and/or user data of a subscriber of a data protection service, wherein the data protection service is accessed, via a telecommunications network, by a computing device of the subscriber of the data protection service, the computing device being connected to the telecommunications network,

wherein in case that a third party service is accessed by the computing device via the telecommunications network, the third party service receives user related data, the user related data being data related to the user identity and/or user data, wherein accessing the third party service via the data protection service involves a transmission of the user related data such that the user identity and/or the user data are at least partly protected and/or anonymized with respect to the third party service
by at least partly avoiding the transmission of the plaintext of the user identity and/or the user data to the third party service, or
by the user related data—transmitted to the third party service—being modified data with respect to the user identity and/or user data of the subscriber.

According to the present invention it is thereby advantageously possible to use third party services—which typically require a user's identity and/or user data (personal data)—such that the user-convenience is improved, in particular with regard to information security and/or privacy protection. Preferably, the information security is improved with regard to user data and/or user identity because third party services may be used either without or only by partly providing the user data and/or user identity (in form of the user related data) to the third party service. Misuse of the personal information by a third party is thereby advantageously inhibited or at least restrained. Preferably, the data protection service is therefore also called a trusted provider. For example, the third party service is a payment service, an application service or electronic commerce service.

According to a preferred embodiment of the present invention, for a first part of the user identity and/or user data, the user related data comprise the plaintext of the user identity and/or user data, and wherein for a second part of the user identity and/or user data, the transmission to the third party service is either avoided or the user related data are modified data with respect to the second part of the user identity and/or user data.

According to the present invention it is thereby advantageously possible to provide at least the second part of the user identity and/or user data to the third party service by a secure method. For example, the data protection service shares the first part (of the user identity and/or user data) openly and the second part (of the user identity and/or user data) in a protected format with the third party service.

According to a preferred embodiment of the present invention, the user identity and/or user data are completely protected and/or anonymized with respect to the third party service
by at least partly avoiding the transmission of the plaintext of the user identity and/or the user data to the third party service, or
by the user related data—transmitted to the third party service—being modified data with respect to the user identity and/or user data of the subscriber.

According to the present invention it is thereby advantageously possible to provide the complete user identity and/or user data to the third party service by a secure method. For example, the data protection service shares all data in a protected format with the third party service.

Within the context of the presented invention, preferably at least a first or a second security level is selected by the subscriber of the computing device with regard to the access to the third party service to the user related data. Preferably, when the first security level (concierge level) is selected, the user identity and/or user data are completely protected and/or anonymized with respect to the third party service. Preferably, when the second security level (protected level) is selected, only a part of the user identity and/or user data is protected and/or anonymized with respect to the third party service.

According to a preferred embodiment of the present invention, the telecommunications network is a mobile communication network, and the computing device is a mobile computing device, such as a mobile phone, a smart phone, a tablet computer, or another portable computing device.

According to the present invention it is thereby advantageously possible to provide the method for protecting and/or anonymizing the user identity and/or user data of the subscriber of the data protected service such that the user convenience is further enhanced.

According to a preferred embodiment of the present invention, the third party service is an application provided to the computing device, wherein the application is executed on the computing device or on a network node of the telecommunications network, wherein by accessing the third party service via the data protection service the behaviour of the application is modified regarding the transmission of the user related data such that the user identity and/or the user data are at least partly protected and/or anonymized with respect to the third party service.

According to the present invention it is thereby advantageously possible to modify the behaviour of the application by applying a response and/or permission approach. Preferably, the behaviour of the application is modified depending on a response and/or permission method being carried out.

According to a preferred embodiment of the present invention, the data protection service comprises a response system for carrying out the response method, wherein the third party service transmits a request message to the response system, the request message being configured to request for user data and/or user identity associated with the subscriber of the data protection service, wherein the response system transmits a response message in response to the request message, wherein the response message comprises the user related data such that the user identity and/or the user data are at least partly protected and/or anonymized with respect to the third party service.

According to the present invention, it is thereby advantageously possible to efficiently hide the user identity and/or user data from the third party service. Preferably, the user related data are configured such that the third party service receives the requested information without sharing the core profile data of the subscriber. For example, the user data may be related to a birthday of the subscriber. The response message may comprise the user related data in the form of a date, e.g. May 20th, rather than the date of birth.

According to a preferred embodiment of the present invention, the data protection service is configured such that the subscriber may register or login with the data protection service using the computing device. In particular, the data protection service provides a login interface for the subscriber. Preferably, the login interface is a graphical user interface comprising an icon, e.g. a TrustMe icon, to be used for login. Preferably, a user account is generated for the subscriber, wherein personal details and/or other configuration details are stored such that the subscriber does not need to enter in the user identity and/or user data each time when the subscriber logs in to the data protection service. It is thereby advantageously possible to improve the user convenience, in particular with respect to the transmission of the user related data to the third party service.

According to a preferred embodiment of the present invention, the method comprises anonymizing the user identity and the user data such that, by analysing the user related data transmitted to the third party service, the user identity associated with the computing device is hidden.

According to the present invention it is thereby advantageously possible to protect and/or anonymize the user identity and/or user data of the subscriber of the data protection service such that the user-convenience is improved with regard to the access of third party services provided via the telecommunications network.

The present invention also relates to a system for protecting and/or anonymizing a user identity and/or user data of a subscriber of a data protection service, the system comprising the data protection service, a telecommunications network, and a computing device, wherein the system is configured such that the data protection service is accessed, via the telecommunications network, by the computing device of the subscriber of the data protection service, the computing device being connected to the telecommunications network, wherein the system is configured such that in case that a third party service is accessed by the computing device via the telecommunications network, the third party service receives user related data, the user related data being data related to the user identity and/or user data, wherein the system is configured such that accessing the third party service via the data protection service involves a transmission of the user related data such that the user identity and/or the user data are at least partly protected and/or anonymized with respect to the third party service
by at least partly avoiding the transmission of the plaintext of the user identity and/or the user data to the third party service, or
by the user related data—transmitted to the third party service—being modified data with respect to the user identity and/or user data of the subscriber.

According to the present invention it is thereby advantageously possible to protect and/or anonymize the user identity and/or user data of the subscriber of a data protection service such that the user-convenience is improved with regard to the access of third party services provided via the telecommunications network. In particular, misuse of personal data is inhibited. The system allows the subscriber to use third party services that require the use of the user related data under improved information security conditions.

According to a preferred embodiment of the present invention, the system is configured such that for a first part of the user identity and/or user data, the user related data comprise the plaintext of the user identity and/or user data, and wherein the system is configured such that for a second part of the user identity and/or user data, the transmission to the third party service is either avoided or the user related data are modified data with respect to the second part of the user identity and/or user data.

According to the present invention it is thereby advantageously possible to provide the user related data to the third party service such that the third party service receives only the first part of the user data and/or user identity in plaintext. Thereby, a second security level (protected level) is realized.

According to a preferred embodiment of the present invention, the system is configured such that the user identity and/or user data are completely protected and/or anonymized with respect to the third party service
by at least partly avoiding the transmission of the plaintext of the user identity and/or the user data to the third party service, or
by the user related data—transmitted to the third party service—being modified data with respect to the user identity and/or user data of the subscriber.

According to the present invention it is thereby advantageously possible to provide the user related data to the third party service such that the third party service receives the complete user data and/or user identity in a secured way. Thereby, a first security level (concierge level) is realized.

According to a preferred embodiment of the present invention, the telecommunications network is a mobile communication network, and the computing device is a mobile computing device, such as a mobile phone, a smart phone, a tablet computer, or another portable computing device.

According to the present invention it is thereby advantageously possible to provide the method for protecting and/or anonymizing the user identity and/or user data of the subscriber of the data protected service such that the user convenience is further enhanced.

Furthermore, the present invention relates to a mobile communication network suitable for protecting and/or anonymizing a user identity and/or user data of a subscriber of a data protection service in a system according to the present invention.

Furthermore, the present invention relates to a program comprising a computer readable program code which, when executed on a computer or on a computing device or on a network component of a telecommunications network or in part on a computing device and in part on a network component of a telecommunications network, causes the computer or the computing device and/or the network component of the telecommunications network to perform a method according to the present invention.

Furthermore, the present invention relates to a computer program product for using a machine type communication device with a telecommunications network, the computer program product comprising a computer program stored on a storage medium, the computer program comprising program code which, when executed on a computer or on a computing device or on a network component of a telecommunications network or in part on a computing device and in part on a network component of a telecommunications network, causes the computer or the computing device and/or the network component of the telecommunications network to perform a method according to the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

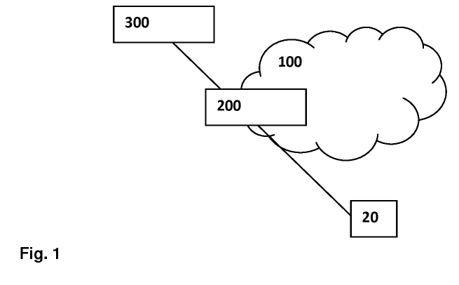

In FIG. 1, a system according to the present invention is illustrated schematically. The system is configured for protecting and/or anonymizing a user identity and/or user data of a subscriber of a data protection service 200. The system comprises the data protection service 200, a telecommunications network 100, and a computing device 20.

According to the present invention, the telecommunications network 100 is preferably an Internet Protocol (IP) based telecommunications network 100. The telecommunications network 100 may include any landline and/or mobile computer network, for example the Internet and/or any telephone network.

The computing device 20 is a computing device of the subscriber of the data protection service 200. The computing device 20 is connected to the telecommunications network 100. The computing device 20 is preferably a personal computer or mobile computer, for example a tablet computer or smartphone or any other computing device.

The system is configured such that the data protection service 200 is accessed, via the telecommunications network 100, by the computing device 20 of the subscriber of the data protection service 200. Preferably, the subscriber—which is herein also called a user of the computing device 20—is registered with the data protection service 200, wherein a personal account is set-up for the user. The data protection service 200 is preferably configured to create a digital passport depending on user data and/or user identity (personal data) and preferably further depending on authorization information of the user. Preferably, the user provides the authorization information (e.g. a permission or level of access) for the third party service 300. In particular, the digital passport is controlled by the user of the computing device 20 and may be updated over time.

The system is configured such that in case that a third party service 300 is accessed by the computing device 20 via the telecommunications network 100, the third party service 300 receives user related data. The user related data are data related to the user identity and/or user data. The user data and/or user identity includes, for example, at least one of the following: name, home address, work address, date of birth, sex, marital status, family details, health details, social network details, email details, calendar/contacts details, bank details, other service provider details e.g. airlines, insurance companies, ecommerce companies, location, devices, personal preferences (profile), internet favorites/bookmarks and usage, safety preferences. It will also be possible to store the digital identity of the subscriber. Preferably, the data protection service 200 is configured such that user identity and/or user data may be added to the digital passport, e.g. in the form of data fields. Preferably, one or more data fields are specified either by the third party service 300 (in case a data element is required which data element is not yet comprised by the digital passport) or the one or more data fields are entered by the user. The data protection service 200 is accessible from any computing device 20 connected to the telecommunications network 100.

Preferably, the data protection service 200 comprises an application interface for communication with a developer of a third party service 300. Preferably, the application interface is configured to connect the third party service 300 (e.g. any application or internet service) to the data protection service 200 such that the third party service 300 is certified as linked to the data protection service 200. Preferably, the data protection service is configured to allow or deny access to third party services. Thereby, it is advantageously possible to exclude illegal or blacklisted services.

According to an embodiment of the system, the system is configured such that accessing the third party service 300 via the data protection service 200 involves a transmission of the user related data such that the user identity and/or the user data are at least partly protected and/or anonymized with respect to the third party service 300 by at least partly avoiding the transmission of the plaintext of the user identity and/or the user data to the third party service 300. According to another embodiment of the system, the system is configured such that accessing the third party service 300 via the data protection service 200 involves a transmission of the user related data such that the user identity and/or the user data are at least partly protected and/or anonymized with respect to the third party service 300 by the user related data—transmitted to the third party service 300—being modified data with respect to the user identity and/or user data of the subscriber. Preferably, modified data means that any direct association of the subscriber to the user data and/or user identity is removed, wherein the user related data is provided in a form that can be used by the third party service. Preferably, the subscriber is thereby enabled to control whether the user data and/or user identity is shared with a third party service 300. In particular, the subscriber is enabled to configure the data protection service 200 such that the user data and/or user identity are at least partly shared openly or at least partly shared securely.

Preferably, the user related data are generated depending on the user data and/or user identity by using a request based method, a protected identity method and/or a permission based method.

In case the request based method is used, the third party service 300 requests user related data, the user related data being requested from the data protection service 200, e.g. via the application interface. The data protection service 200 requests, depending on the request of the user related data by the third party service, from the subscriber at the computing device 20 authorization information related to the third party service 300. According to the present invention, preferably
an accept message is sent from the data protection service 200 to the third party service 300, if access of the third party service 300 to the user related data is allowed, via the computing device 20, by the subscriber or
a deny message is sent from the data protection service 200 to the third party service 300, if access of the third party service 300 to the user related data is denied, via the computing device 20, by the subscriber.

In case the protected identity method is used, the user related data comprises an identifier (ID), wherein the ID is related to the subscriber, wherein the relationship between the subscriber and the ID is a trusted relationship existing (only) within the data protection service 200. Preferably, the ID is provided to the third party service 300 in a fraudulent way, i.e. without any possibility for the third party service to know the true identity of the subscriber (user identity). For example, the ID is a randomly generated digital identity, which is, in particular, generated for each session separately. Preferably, the ID is only unique to the subscriber once per session with the third party service 300 (as it changes each time).

In case the permission based system is used, no user related data is provided to the third party service 300. Instead, a granting system is used, wherein the subscriber is enabled to assign at least one piece of authorization information (e.g. permissions) per third party service 300 and, in particular, per data the subscriber wishes to use for a selected third party service 300. Preferably, the subscriber is enabled to allow different degrees of privacy or security levels. For example, personal data may be shared for payment services but not for unknown third party services 300.

Preferably, when a first security level is selected by the subscriber, the data protection service 200 protects (e.g. excludes or hides)—with regard to the third party service 300—at least first information (and optionally second and/or third information) of the user data and/or user identity. Preferably, when the second security level is selected by the subscriber, the data protection service 200 protects at least second information (and optionally third information) of the user data and/or user identity. Preferably, when a third security level is selected by the user, the data protection service 200 (only) protects third information of the user data and/or user identity. According to one example, the first information relates to at least one of credit card details, bank account details, passport details, national insurance and/or other personal details a customer rarely gives out only in a trusted environment. According to one example, the second information relates to at least one of date of birth, email login, social network login and/or other useful sites/passwords. According to one example, the third information relates to first name, surname, address, email address, marital status, male/female, age and/or other personal details a subscriber usually gives out on a frequent basis to websites.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for protecting and/or anonymizing a user identity and/or user data of a subscriber of a data protection service, comprising:
accessing, by a computing device of the subscriber connected to a telecommunications network, the data protection service via the telecommunications network; and
accessing, by the computing device, a third party service via the data protection service such that the third party service receives user-related data, the user-related data being data related to the user identity and/or the user data;
wherein accessing the third party service via the data protection service involves a transmission of the user-related data such that the user identity and/or the user data are at least partly protected and/or anonymized with respect to the third party service by at least partly avoiding transmission of plaintext of the user identity and/or the user data to the third party service, or by the user-related data—transmitted to the third party service being modified data with respect to the user identity and/or user data.

2. The method according to claim 1, wherein for a first part of the user identity and/or the user data, the user-related data comprise comprises the plaintext of the user identity and/or user data, and wherein for a second part of the user identity and/or the user data, transmission to the third party service is either avoided or the user-related data is modified data with respect to the second part of the user identity and/or the user data.

3. The method according to claim 1, wherein the user identity and/or the user data are completely protected and/or anonymized with respect to the third party service by at least partly avoiding the transmission of the plaintext of the user identity and/or the user data to the third party service, or by the user related data—transmitted to the third party service being modified data with respect to the user identity and/or the user data.

4. The method according to claim 1, wherein the telecommunications network is a mobile communication network, and the computing device is a mobile computing device.

5. The method according to claim 1, wherein the third party service an application provided to the computing device, wherein the application is executed on the computing device or on a network node of the telecommunications network, wherein by accessing the third party service via the data protection service the behaviour of the application is modified regarding the transmission of the user-related data such that the user identity and/or the user data are at least partly protected and/or anonymized with respect to the third party service.

6. The method according to claim 1, further comprising:
anonymizing the user identity and the user data such that, the user identity associated with the computing device is hidden.

7. A system for protecting and/or anonymizing a user identity and/or user data of a subscriber of a data protection service, the system comprising:
the data protection service;
a telecommunications network;
a computing device;
wherein the computing device is connected to the telecommunications network and configured to access the data protection service, via. the telecommunications network:
wherein the computing device is further configured to access a third party service via the data protection service such that the third party service receives user-related data, the user-related data being data related to the user identity and/or the user data;
wherein accessing the third party service via the data protection service involves a transmission of the user-related data such that the user identity and/or the user data are at least partly protected and/or anonymized with respect to the third party service by at least partly avoiding transmission of plaintext of the user identity and/or the user data to the third party service or by the user-related data—transmitted to the third party service being modified data with respect to the user identity and/or the user data.

8. The system according to claim 7, wherein for a first part of the user identity and/or the user data, the user-related data comprises the plaintext of the user identity and/or the user data, and wherein for a second part of the user identity and/or the user data, transmission to the third party service is either avoided or the user-related data is modified data with respect to the second part of the user identity and/or the user data.

9. The system according to claim 7, wherein the user identity and/or the user data are completely protected and/or anonymized with respect to the third party service by at least partly avoiding transmission of the plaintext of the user identity and/or the user data to the third party service or by the user related data—transmitted to the third party service being modified data with respect to the user identity and/or the user data the.

10. The system according to claim 7, wherein the telecommunications network is a mobile communication network, and the computing device is a mobile computing device.

11-12. (canceled)

13. A non-transitory computer-readable medium having processor-executable instructions stored thereon for using a computing device with a telecommunications network for protecting and/or anonymizing a user identity and/or user data of a subscriber of a data protection service, the processor-executable instructions, when executed. facilitating, performance of the following steps:
accessing, by the computing device of the subscriber, the data protection service via the telecommunications network; and
accessing, by the computing device, a third party service via the data protection service such that the third party service receives user-related data being data related to the user identity and/or; the user data:
wherein accessing the third party service via the data protection service involves transmission of the user-related data such that the user identity and/or the user data are at least partly protected and/or anonymized with respect to the third party service by at least partly avoiding transmission of plaintext of the user identity and/or the user data to the third party service or by the user-related data transmitted to the third party service being modified data with respect to the user identity and/or user data.
